(19) United States
(12) Patent Application Publication
(10) Pub. No.: US 2012/0321107 A1
(43) Pub. Date: Dec. 20, 2012

(54) SPEAKER ASSEMBLY WITH AIR RETARDING CUSHION

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/207,428

(22) Filed: Aug. 11, 2011

(30) Foreign Application Priority Data
Jun. 17, 2011 (CN) 201110163948.5

(51) Int. Cl. H04R 25/00

(52) U.S. Cl. 381/150

(57) ABSTRACT

An exemplary speaker assembly includes a housing, a loudspeaker, a sound-guiding channel and a cushion with a plurality of meshes. The housing has a receiving chamber and an acoustic chamber. The loudspeaker is accommodated in the receiving chamber. The sound-guiding channel is formed in the acoustic chamber. The sound-guiding channel has a first end with a first opening to communicate the sound-guiding channel and a second end with a second opening to communicate the sound-guiding channel with surrounding environment. The cushion is formed at the first opening of the sound-guiding channel for slowing down air flowed from the rear side of the loudspeaker to the sound-guiding channel.

### BACKGROUND

1. Technical Field

The disclosure generally relates to speaker assemblies, and more particularly to a speaker assembly having a sound-guiding channel.

2. Description of Related Art

In some applications, a speaker assembly is provided with a sound-guiding channel. Sound generated at a rear side of a loudspeaker is emitted to the surrounding environment through the sound-guiding channel and then resonates with sound generated at a front side of the loudspeaker. Therefore, the sound quality of the speaker assembly at low frequencies is improved. However, when air enters the sound-guiding channel, the speed of moving air inside the sound-guiding channel increases, and friction between the air and the walls of the sound-guiding channel generates noise.

What is needed, therefore, is a speaker assembly to overcome the described limitations.

### BRIEF DESCRIPTION OF THE DRAWINGS

FIG. 1 is an isometric view of a speaker assembly in accordance with an embodiment of the present disclosure.

FIG. 2 is an exploded view of the speaker assembly in FIG. 1.

FIG. 3 is an isometric view of a front shell of the speaker assembly in FIG. 2, but showing the front shell inverted.

FIG. 4 is an assembled view of a rear cover, a front shell and a cushion of the speaker assembly in FIG. 2.

FIG. 5 is an isometric view of a rear shell of the speaker assembly in FIG. 2, but showing the rear shell inverted.

### DETAILED DESCRIPTION

An embodiment of a speaker assembly will now be described in detail below and with reference to the drawings.

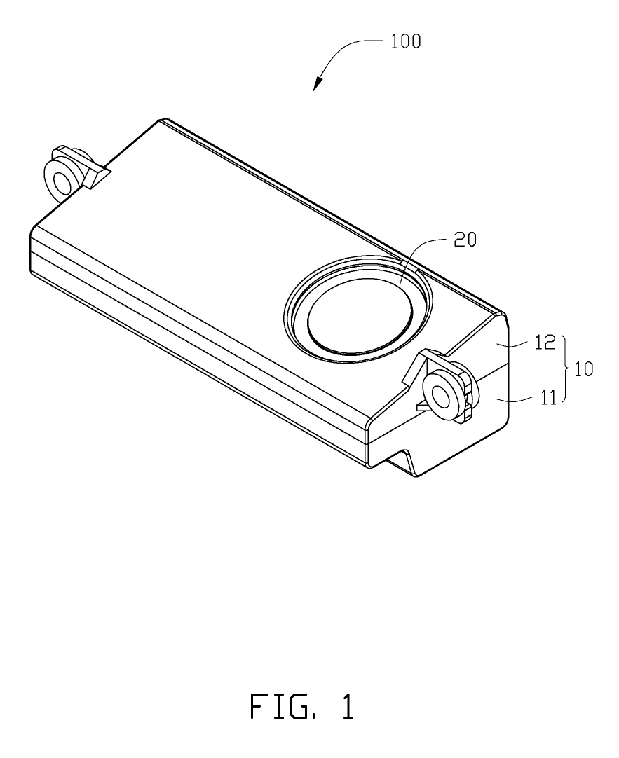

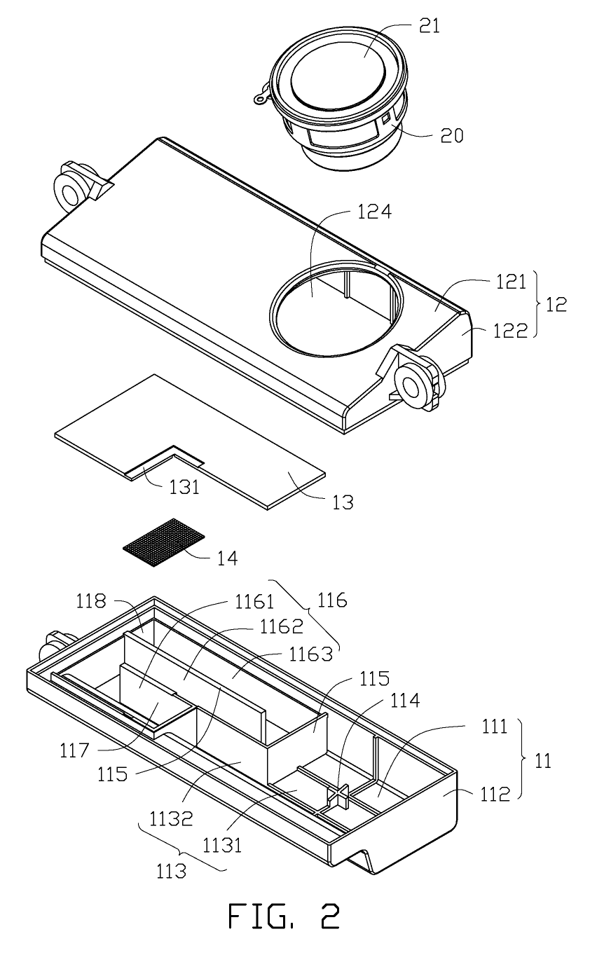

Referring to FIGS. 1-2, the speaker assembly 100 includes a housing 10, and a loudspeaker 20 secured in the housing 10.

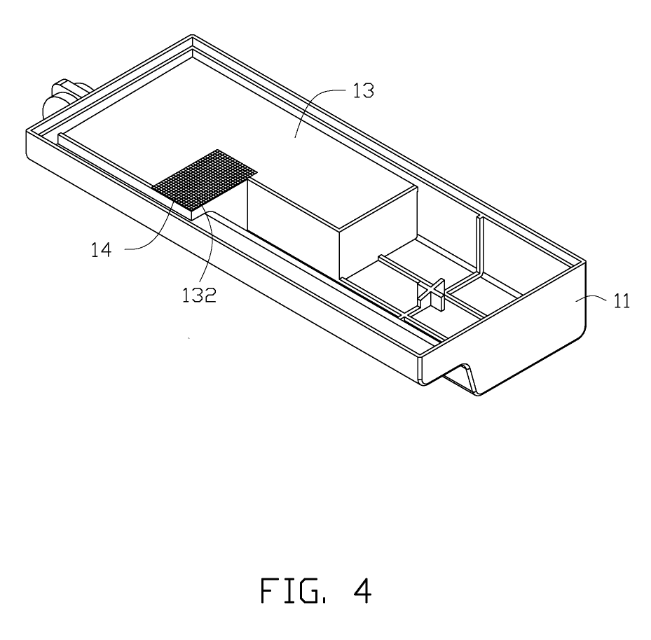

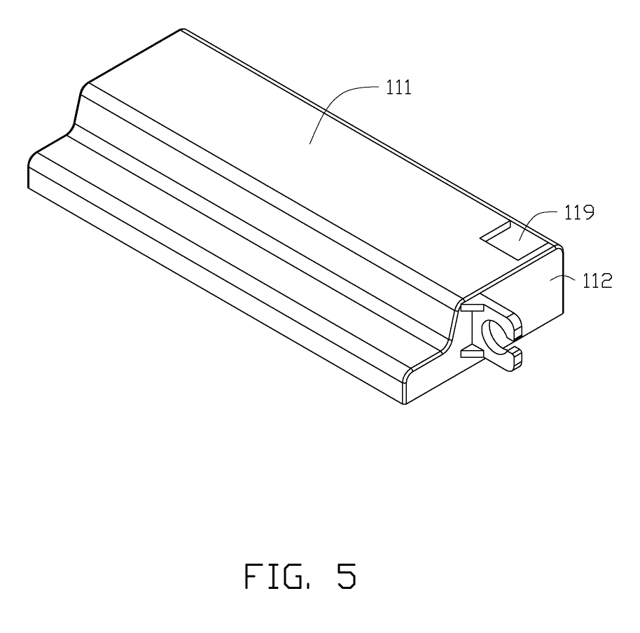

The housing 10 includes a rear shell 11, and a front shell 12 connected with the rear shell 11. Referring also to FIGS. 4-5, the rear shell 11 includes a bottom wall 111, and a side wall 112 extending upwardly from the bottom wall 111. The bottom wall 111 and the side wall 112 cooperatively define a first chamber 113. The first chamber 113 includes a first receiving chamber 1131 for accommodating the loudspeaker 20, and a first acoustic chamber 1132 communicating with the first receiving chamber 1131. A cross-shaped supporting member 114 is formed on an inner surface of the bottom wall 111 for supporting the loudspeaker 20. Spacing plates 115 are formed in the first acoustic chamber 1132, and connect with the bottom wall 111 and the side wall 112. A covering plate 13 is formed on an upper side of the spacing plates 115.

The spacing plates 115, the bottom wall 111 and side wall 112 of the rear shell 11, together with the covering plate 13, cooperatively define a sound-guiding channel 116. The sound-guiding channel 116 has a first end 117 and a second end 118. The covering plate 13 defines a first opening 132 at the first end 117, and a second opening 119 at the second end 118. The first opening 132 communicates the first end 117 of the sound-guiding channel 116 with the first acoustic chamber 1132. The second opening 119 communicates the second end 118 of the sound-guiding channel 116 with surrounding environment. The first opening 132 and the second opening 119 both are rectangular.

In this embodiment, the sound-guiding channel 116 includes a first section 1161, a second section 1162 and a third section 1163 all parallel to each other. The second section 1162 is between the first section 1161 and the third section 1163. Two ends of the second section 1162 communicate with the first section 1161 and the third section 1163. In addition, a length of the first section 1161 is less than a length of the second section 1162. A cushion 14 with at least one mesh is disposed in the first opening 132 for slowing down the speed of air flowing into the sound-guiding channel 116 via the first opening 132. The cushion 14 can be a wire netting, a nylon netting, or an adhesive-bonded fabric. A groove 131 is defined on an upper surface of the covering plate 13 in a position adjacent to the first opening 132, for securing a periphery of the cushion 14. In this embodiment, the cushion 14 is rectangular, and a periphery of the cushion 14 is adhered to the covering plate 13 and the spacing plate 115.

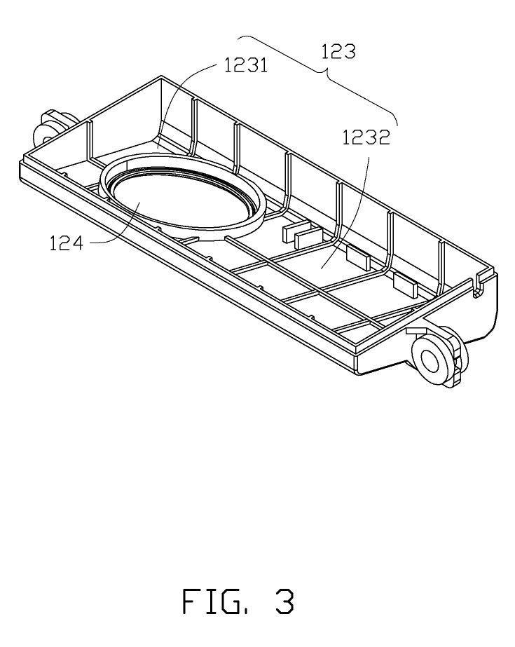

Referring to FIGS. 2-3, the front shell 12 includes an upper wall 121, and a side wall 122 extending downwardly from the upper wall 121. The upper wall 121 and the side wall 122 cooperatively form an upper chamber 123. The upper chamber 123 includes a second receiving chamber 1231 for receiving the loudspeaker 20, and a second acoustic chamber 1232 communicating with the second receiving chamber 1231. The second receiving chamber 1231 and the second acoustic chamber 1232 correspond to the first receiving chamber 1131 and the first acoustic chamber 1132, respectively. A through hole 124 is defined in the upper wall 121 for exposing the second receiving chamber 1231.

In assembling of the speaker assembly 100, the rear shell 11 and the front shell 12 are connected together to form a housing 10. The first receiving chamber 1131 and the second receiving chamber 1231 cooperatively form a receiving chamber for accommodating the loudspeaker 20. The first acoustic chamber 1132 and the second acoustic chamber 1232 cooperatively form an acoustic chamber of the housing 10. The acoustic chamber is positioned at one side of the loudspeaker 20, and sound generated at a rear side of the loudspeaker 20 resonates in the acoustic chamber. The loudspeaker 20 corresponds to the through hole 124. The loudspeaker 20 has a front end adjacent to a diaphragm 21, and a rear end supported by the supporting member 114. The edge portion of the front end of the loudspeaker 20 is secured to the upper wall 121 of the front shell 12, and exposed to the surrounding environment via the through hole 124.

In operation, the diaphragm 21 vibrates, and sounds are generated from the front side and the rear side of the loudspeaker 20. Sound generated at the front side of the loudspeaker 20 transmits to the surrounding environment via the through hole 124. Sound generated at the rear side of the loudspeaker 20 transmits to the sound-guiding channel 116 through the first opening 132, and then to the surrounding environment through the second opening 119. Therefore, sound coming from the through hole 124 resonates with sound coming from the second opening 119, and the sound properties of the speaker assembly 100 at low frequencies are improved.

In addition, in the speaker assembly 100, the cushion 14 is positioned at the first opening 132 of the first end 117 of the sound-guiding channel 116. The cushion 14 can lower the speed of air flowing into the sound-guiding channel 116. Therefore friction between moving air in the sound-guiding channel 116 and the walls of the sound-guiding channel 116 is reduced, and the sound properties of the speaker assembly 100 are further improved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A speaker assembly, comprising:
a housing defining a receiving chamber and an acoustic chamber communicating with the receiving chamber;
a loudspeaker accommodated in the receiving chamber in a position adjacent to the acoustic chamber;
a sound-guiding channel formed in the acoustic chamber, the sound-guiding channel comprising a first end and a second end, the first end having a first opening to communicate the sound-guiding channel with the acoustic chamber, and the second end having a second opening to communicate the sound-guiding channel with the surrounding environment of the speaker assembly; and
a cushion, comprising at least one mesh, provided in the first opening of the sound-guiding channel.

2. The speaker assembly of claim 1, wherein the cushion is made of an item selected from the group consisting of wire netting, nylon netting and adhesive-bonded fabric.

3. The speaker assembly of claim 1, wherein the housing comprises a rear shell and a front shell connected together and the front shell has a through hole defined therein to expose the loudspeaker to the surrounding environment of the speaker assembly.

4. The speaker assembly of claim 3, wherein the rear shell comprises a plurality of spacing plates and a covering plate covering the spacing plates, the spacing plates, the rear shell and the covering plate cooperatively forming the sound-guiding channel.

5. The speaker assembly of claim 4, wherein the sound-guiding channel comprises a first section, a second section and a third section all parallel to each other, the second section is located between the first section and the third section, and the second section has two ends communicating with the first section and the third section respectively.

6. The speaker assembly of claim 5, wherein a length of the first section is less than that of the second section.

7. The speaker assembly of claim 4, wherein a groove is defined at the covering plate in a position adjacent to the first opening for partly securing a peripheral edge of the cushion.

8. The speaker assembly of claim 7, wherein the cushion is substantially rectangular, and an outer peripheral edge of the cushion is secured to the covering plate and the spacing plates.

9. A speaker assembly, comprising:
a housing;
a loudspeaker received in the housing, the loudspeaker having a front side and a rear side, the front side exposed to the surrounding environment;
a sound-guiding channel, comprising a first end communicating with the rear side of the loudspeaker through a first opening, and a second end communicating with the surrounding environment of the speaker assembly through a second opening; and
a cushion provided at the first opening of the sound-guiding channel for slowing down air flowing from the rear side of the loudspeaker to the sound-guiding channel.

10. The speaker assembly of claim 9, wherein the cushion comprises a plurality of meshes.

11. The speaker assembly of claim 9, wherein the cushion is made of wire netting, nylon netting or adhesive-bonded fabric.

12. The speaker assembly of claim 9, wherein the housing comprises a rear shell and a front shell connected together, a through hole is defined at the front shell to expose the loudspeaker to surrounding environment.

13. The speaker assembly of claim 12, wherein the rear shell comprises several spacing plates and a covering plate covering the spacing plates, the spacing plates, rear shell and the covering plate cooperatively form the sound-guiding channel.

14. The speaker assembly of claim 13, wherein the sound-guiding channel comprises a first section, a second section and a third section paralleled to each other, the second section is located between the first section and the third section, and has two ends communicating with the first section and the third section respectively.

15. The speaker assembly of claim 14, wherein a length of the first section is less than that of the second section.
